(19) United States
(12) Patent Application Publication
(10) Pub. No.: US 2016/0309456 A1
(43) Pub. Date: Oct. 20, 2016

(54) INFERENCE ALIGNMENT (IA) METHOD FOR DOWNLINK IN WIRELESS LOCAL AREA NETWORK (WLAN) SYSTEM, ACCESS POINT (AP) AND USER TERMINAL FOR PERFORMING THE SAME

(71) Applicant: ELECTRONICS AND TELECOMMUNICATIONS RESEARCH INSTITUTE, Daejeon (KR)

(72) Inventors: Min Ho CHEONG, Daejeon (KR); Hyoung Jin KWON, Sejong (KR); Sok Kyu LEE, Daejeon (KR); Jae Seung LEE, Daejeon (KR)

(21) Appl. No.: 15/132,127

(22) Filed: Apr. 18, 2016

(30) Foreign Application Priority Data
Apr. 20, 2015 (KR) 10-2015-0055371

(51) Int. Cl. H04W 72/04; H04B 7/04; H04W 52/24

(52) U.S. Cl. CPC H04W 72/046; H04W 52/241; H04B 7/0452; H04W 84/12

(57) ABSTRACT

An interference alignment (IA) method for a downlink in a wireless local area network (WLAN) system, an access point (AP) and a user terminal for performing the same are provided, wherein the AP may broadcast beam information on randomly selected beams and calculate an leakage of interference (LIF) based on the beam information received from the AP, the user terminal may generate feedback information including LIF information and transmit the feedback information to the AP, and the AP may determine a transmission power term with respect to each beam based on the feedback information received from the user terminal and transmit data to the user terminal based on the determined transmission power term.

### CROSS-REFERENCE TO RELATED APPLICATION

This application claims the priority benefit of Korean Patent Application No. 10-2015-0055371, filed on Apr. 20, 2015, in the Korean Intellectual Property Office, the disclosure of which is incorporated herein by reference.

### BACKGROUND

1. Field of the Invention

Embodiments relate to an interference alignment (IA) method for a downlink in a wireless local area network (WLAN) system, an access point (AP) and a user terminal for performing the same.

2. Description of the Related Art

A near field communication network, for example, a local area network (LAN) is generally classified into a wired LAN and a wireless LAN (WLAN). In the WLAN, communication may be performed on a network using radio wave in lieu of using cable. The WLAN has been proposed as an alternative for outperforming difficulties in maintenance and repair, movement, and installation of cabling. Due to an increase in mobile device users, the need for the WLAN is also increasing.

A WLAN system includes an access point (AP), and a user terminal. The user terminal may also be referred to as a station (STA). The AP is a device for transmitting a radio wave in order that the user terminals are available to use network or access Internet within a service range. The WLAN system uses an IEEE 802.11 standard released by an institute of electrical and electronics engineers (IEEE).

A basic constituent block of an IEEE 802.11 network is a basic service set (BSS). In the IEEE 802.11 network, there is an extended service set that extends a service area by connecting an independent network, for example, an independent BSS, to an infrastructure network, for example, an infrastructure BSS. In the independent network, terminals within the BSS may perform direct communication with each other. In the infrastructure network, an AP may be involved in communication performed between a terminal and another terminal existing inside or outside the BSS.

In general, an IEEE 802.11 based WLAN system may access a medium based on a carrier sense multiple access/collision avoidance (CSMA/CA) scheme, and each AP may operate independently. Thus, in the WLAN system, the AP may independently select a channel using an operator or a channel allocation algorithm. Due to this, a communication channel used by each BSS may overlap when many WLAN systems are provided. When the communication channel overlaps, interference may occur between adjacent BSSs thereby reducing network performance. Therefore, a communication method of effectively reducing the interference occurring in the WLAN system is required.

### SUMMARY

According to an aspect, there is provided an interference alignment (IA) method performed by an access point (AP) including broadcasting beam information on randomly selected beams, receiving, from user terminals, feedback information including leakage of interference (LIF) information on each beam, determining a transmission power term with respect to each beam based on the feedback information, and transmitting data based on the determined transmission power term.

The IA method may further include selecting at least one user terminal to which the data is to be transmitted from the user terminals.

The determining may include determining the transmission power term based on signal gain information and the LIF information received from the at least one selected user terminal.

The determining may include calculating a power allocation vector based on a first matrix corresponding to the LIF information received from the at least one selected user terminal and a second matrix corresponding to the signal gain information received from the selected at least one user terminal, scaling the power allocation vector, and determining the transmission power term based on the scaled power allocation vector.

The feedback information may further include signal to interference plus noise ratio (SINR) information.

The determining may include determining the transmission power term with respect to each of the beams based on the LIF information and the SINR information.

The broadcasting may include randomly selecting a transmission vector space, and broadcasting beam information based on information on the selected transmission vector space.

The selecting may include selecting the at least one user terminal to which the data is to be transmitted from the user terminals based on a level of an SINR measured by the user terminals.

The selecting may include selecting at least one user terminal to which the data is to be transmitted for each subchannel or each stream based on the feedback information.

The IA method may further include broadcasting information on the at least one selected user terminal.

The LIF information may include at least one of information on an interference occurring at another user terminal within a service area of the AP and information on an interference occurring at another AP.

According to another aspect, there is also provided an interference alignment (IA) method performed by a user terminal, the method including receiving beam information on randomly selected beams from an access point (AP), generating feedback information including leakage of interference (LIF) information on each beam based on the beam information, transmitting the generated feedback information to the AP, and receiving data from the AP according to a transmission power term determined based on the feedback information.

The transmission power term may be determined based on the LIF information on each beam and signal gain information calculated by the user terminal.

The AP may select at least one user terminal to which the data is to be transmitted from user terminals, and the transmission power term may be determined based on a first matrix corresponding to the LIF information received from the at least one selected user terminal and a second matrix based on signal gain information received from the at least one selected user terminal.

The generating may include generating the feedback information further including signal gain information and a signal to interference plus noise ratio (SINR) information.

According to still another aspect, there is also provided an access point (AP), including a communicator configured to broadcast beam information on randomly selected beams and receive feedback information from user terminals, and a transmission power determiner configured to determine a transmission power term with respect to each beam based on leakage of interference (LIF) information on each beam included in the feedback information.

The AP may further include a user terminal selector configured to select at least one user terminal to which data is to be transmitted for each subchannel or each stream based on the feedback information.

The transmission power determiner may be configured to determine the transmission power term based on signal gain information and the LIF information received from the at least one selected user terminal.

The transmission power determiner may be configured to calculate a power allocation vector based on a first matrix based on the LIF information received from the at least one selected user terminal and a second matrix based on the signal gain information received from the at least one selected user terminal, and determine the transmission power term based on the power allocation vector.

The communicator may be configured to broadcast information on the at least one selected user terminal and transmit data to the at least one selected user terminal based on the determined transmission power term.

The AP may randomly select a transmission vector space and further include a beam information generator configured to generate the beam information based on the selected transmission vector space.

According to yet another aspect, there is also provided an access point (AP), including a communicator configured to broadcast beam information on randomly selected beams and receive feedback information from user terminals, a user terminal selector configured to select at least one user terminal to which data is to be transmitted for each subchannel and each stream based on the feedback information, and a transmission power determiner configured to determine a transmission power term with respect to each beam based on leakage of interference (LIF) information received from the at least one selected user terminal.

According to further aspect, there is also provided a user terminal including a feedback information generator configured to generate feedback information including leakage of interference (LIF) information on each beam based on beam information received from an access point (AP), and a communicator configured to receive the beam information from the AP and transmit the feedback information to the AP.

The communicator may receive data from the AP based on a transmission power term determined by the AP, and the transmission power term may be determined based on the LIF information on each beam and signal gain information calculated by the user terminal.

The AP may select at least one user terminal to which data is to be transmitted for each subchannel or each stream based on the feedback information, and the transmission power term may be determined based on a first matrix corresponding to the LIF information received from the at least one selected user terminal and a second matrix corresponding to the signal gain information received from the at least one selected user terminal.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of an interference environment of a wireless local area network (WLAN) system according to an embodiment;

FIG. 2 is a diagram illustrating a configuration of an access point (AP) according to an embodiment;

FIG. 3 is a diagram illustrating a configuration of a user terminal according to an embodiment;

FIG. 4A and 4B are diagrams illustrating feedback information generated by a user terminal according to an embodiment;

FIG. 5 is a diagram illustrating a protocol of opportunistic interference alignment (OIA) occurring between an AP and a user terminal according to an embodiment;

FIG. 6 is a flowchart illustrating a method for IA performed by an AP according to an embodiment;

FIG. 7 is a flowchart illustrating a method for IA performed by a user terminal according to an embodiment; and

FIG. 8 is a diagram illustrating a method of controlling a transmission power based on a signal to interference plus noise ratio (SINR) according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Hereinafter, embodiments of the present invention will be described with reference to the accompanying drawings. The detailed description to be disclosed in the following with the accompanying drawings is provided to describe the embodiments and is not to describe a sole embodiment capable of implementing the present invention. The following description may include specific details to provide the full understanding of the present invention. However, it will be apparent to a person of ordinary skill that the present invention may be carried out even without the specific details.

The following embodiments may be provided in a form in which constituent elements and features of the present invention are combined. Each constituent element or feature may be construed to be selective unless explicitly defined. Each constituent element or feature may be implemented without being combined with another constituent element or feature. Also, the embodiments may be configured by combining a portion of constituent elements and/or features. Orders of operations described in the embodiments may be changed. A partial configuration or feature of a predetermined embodiment may be included in another embodiment, and may also be changed with a configuration or a feature corresponding to the other embodiment.

Predetermined terminologies used in the following description are provided to help the understanding of the present invention and thus, use of predetermined terminology may be changed with another form without departing from the technical spirit of the present invention.

In some cases, a known structure and device may be omitted or may be provided as a block diagram based on a key function of each structure and device in order to prevent the concept of the present invention from being ambiguous. In addition, like reference numerals refer to like constituent elements throughout the present specification.

The embodiments may be supported by standard documents disclosed in at least one of wireless access systems, for example, an Institute of Electrical and Electronic Engineers (IEEE) 802 system, a Third Generation Partnership Project (3GPP) system, a 3GPP Long Term Evolution (LTE) and LTE-Advanced (LTE-A) system, and a 3GPP2 system. That is, operations or portions not described to clearly disclose the technical spirit of the present invention among the embodiments may be supported by the standard documents. Further, all the terminologies used herein may be explained by the standard documents.

The following technology may be employed for a variety of wireless access systems, for example, a code division multiple access (CDMA), a frequency division multiple access (FDMA), a time division multiple access (TDMA), an orthogonal frequency division multiple access (OFDMA), and a single carrier frequency division multiple access (SC-FDMA). The CDMA may be embodied using a wireless technology such as a universal terrestrial radio access (UTRA) or CDMA 2000. The TDMA may be embodied using a wireless technology such as a global system for mobile communications (GSM)/general packet radio service (GPRS)/enhanced data rates for GSM evolution (EDGE). The OFDMA may be embodied using a wireless technology such as IEEE 802.11 (Wi-Fi), IEEE 802.16 (WiMAX), IEEE 802-20, and evolved UTRA (E-UTRA). For clarity and conciseness, description is made generally based on an IEEE 802.11 system, however, the technical spirit of the present invention is not limited thereto or restricted thereby.

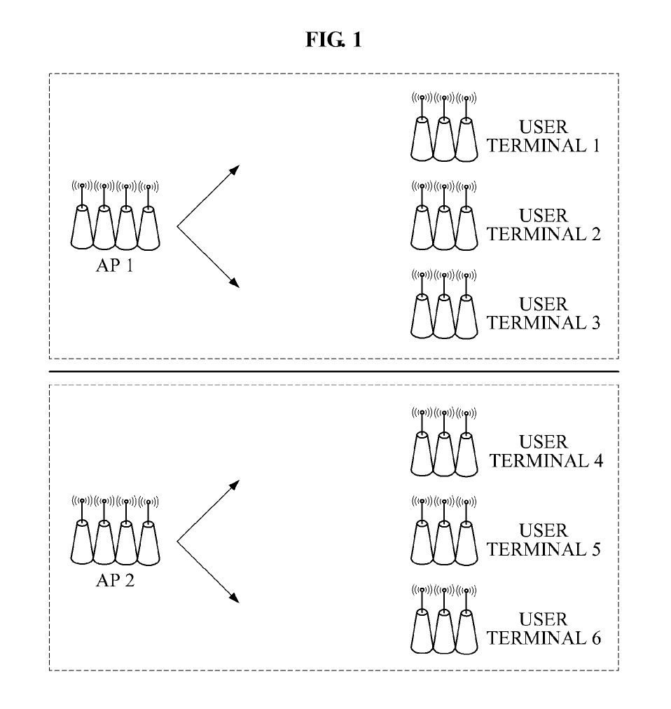

FIG. 1 is a diagram illustrating an example of an interference environment of a wireless local area network (WLAN) system according to an embodiment.

A WLAN system may include at least one basic service set (BSS). The BSS may be provided in an access point (AP) and at least one of user terminals.

The AP is a functional entity to provide an access to a distribution system via wireless entities for a user terminal associated with an AP. The AP may communicate with at least one user terminal through a downlink or an uplink. The downlink is a communication link from the AP to the user terminal, and the uplink is a communication link from the user terminal to the AP. The user terminal may perform peer-to-peer (P2P) communication with another user terminal.

Communication between the user terminals via an AP is a principle of a BSS including the AP. However, when a direct link is set between the user terminals, the user terminals may directly perform communication without via AP. For example, the AP refers to as a central controller, a base station (BS), a node-B, or a based transceiver system (BTS) and the AP may be realized by way of the foregoing.

The user terminal refers to as a mobile terminal, a wireless device, a wireless transmit and receive unit (WTRU), a user equipment (UE), a mobile station (MS), a mobile subscriber unit, or, simply, a user. The AP may be realized by way of the foregoing.

The AP may simultaneously transmit data to a user terminal group including at least one user terminal among a plurality of user terminals associated with the AP.

The WLAN system supports multi-user multiple-input multiple-output (MU-MIMO) communication. In the MU-MIMO communication system, the AP may transmit a number of space streams to the plurality of user terminals using multiple antennas. In addition, when the AP uses a number of receiving antennas, the AP may transmit data frames to the user terminals based on beamforming technology to enhance transmission performance.

A wireless transmission environment of the WLAN system as illustrated in FIG. 1 is assumed to include two APs, three user terminals for each AP network, four antennas for each AP, and three antennas for each user terminal. The AP network is provided with the AP and at least one user terminal included in a service range of the AP. The user terminal refers to as a station (STA).

Each AP includes a plurality of antennas and each user terminal also includes a plurality of antennas. A plurality of user terminals is available to access to each AP network, and each user terminal may receive a downlink message symbol from the AP of the AP network to which corresponding user terminal belongs.

Each user terminal may receive a message symbol using the plurality of antennas and reduce an effect of interference by another AP network in a symbol decoding process.

When the plurality of user terminals receives and transmits the message symbol in a wireless interference channel environment, each user terminal may receive an interference signal in addition to a desired purpose signal. In the wireless interference channel environment, when the AP transmits a signal to the user terminals in the AP network to which the corresponding AP belongs, the signal received by each terminal may be expressed by Equation 1.

$${r}_{g , {Φ}_{g} ( s )} = {H}_{g}^{g , {Φ}_{g} ( s )} {v}_{g , s} {s}_{g , {Φ}_{g} ( s )} + {\sum }_{l = 1 , l \neq s}^{S} {H}_{g}^{g , {Φ}_{g} ( s )} {v}_{g , l} {s}_{g , {Φ}_{g} ( l )} + {{\sum }_{k \neq g}}^{K} {\sum }_{l = 1}^{S} {H}_{k}^{g , {Φ}_{g} ( s )} {v}_{k , l} {s}_{k , {Φ}_{k} ( l )} + {n}_{g , {Φ}_{g} ( s )} , \qquad [ Equation 1 ]$$

In Equation 1, r_{g}, Φ_{g}(s) denotes a signal vector received by a user terminal Φ_{g}(s) belonging to a network of an AP g, Hₖ^{g,Φ}^{ₛ}^{(s)} denotes a wireless channel matrix between an AP k and the user terminal Φ_{g}(s), V_{g,s} denotes a transmission vector for an s-th symbol stream in the network of the AP g, and n_{g}, Φ_{g}(s) denotes white Gaussian noise in the user terminal Φ_{g}(s) in the network of the AP g. Here, Φ_{g}(s) denotes a user terminal obtaining a reception opportunity for the s-th symbol stream in the network of the AP g.

When message symbols are simultaneously transmitted from a plurality of AP networks, a throughput of entire network may decrease due to an interference phenomenon. Thus, to prevent a decrease in a throughput of the network due to the interference phenomenon, interference coordination may be needed.

The AP may transmit the downlink message symbol to a user terminal based on an opportunistic interference alignment (OIA) scheme. The OIA scheme is a scheme to provide a communication opportunity to the user terminal, in advance, with an optimal alignment from the plurality of user terminals. For example, an AP may provide a communication opportunity to a terminal least affected by interference. The AP may prevent an interference signal of a lower priority user terminal from affecting a signal of a higher priority user terminal. The AP may select user terminals least affected by the interference from another AP network, and broadcast information associated with the selected user terminals. The AP may select, from the user terminals, user terminals to which data is to be transmitted based on a communication environment of each user terminal. The AP may determine a transmission power term based on feedback information received from the user terminals and transmit the data to the user terminals selected based on the determined transmission power term.

A user terminal in a relatively excellent communication environment may obtain an opportunity to receive data, for example, a message symbol, thereby decreasing interference between each AP network and enhancing the throughput of the entire network.

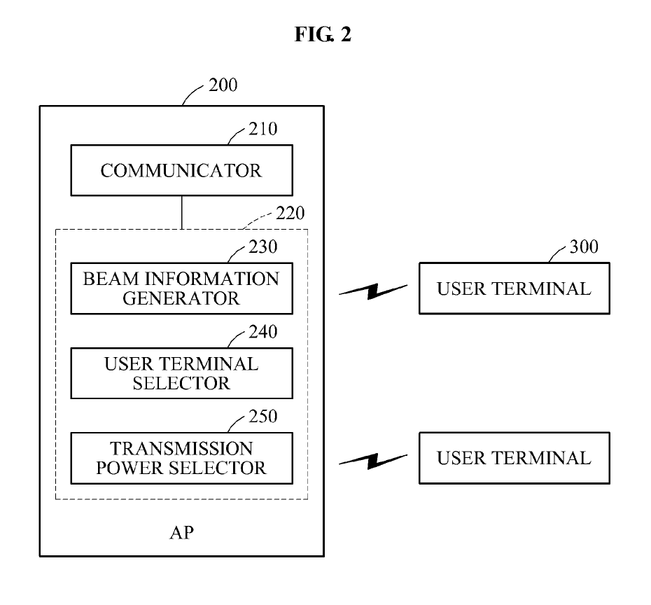

FIG. 2 is a diagram illustrating a configuration of an access point (AP) according to an embodiment.

Referring to FIG. 2, an AP 200 includes a communicator 210 and a controller 220, and the controller 220 includes a beam information generator 230, a user terminal selector 240, and a transmission power selector 250.

The beam information generator 230 generates beam information on randomly selected beams. The beam information generator 230 may randomly select a transmission vector space and generate the beam information on the selected transmission vector space. The transmission vector space refers to a communication channel to which a signal vector is transmitted by the AP 200.

For example, the beam information generator 230 may randomly generate orthogonal unit vectors, select a set of predetermined orthogonal random beams, and generate information on the selected set of orthogonal random beams as beam information. The communicator 210 may broadcast the generated beam information.

A user terminal 300 may receive the beam information from the AP 200 and identify information on the transmission vector space selected by the AP 200 based on the beam information. The user terminal 300 may calculate a signal to interference plus noise ratio (SINR) expected based on the information on the transmission vector space.

The user terminal 300 may calculate a leakage of interference (LIF) with respect to each beam based on the beam information received from the AP 200. The user terminal 300 may calculate the LIF with respect to an inter-user interference (IUI) or interference from another AP. The LIF may indicate a degree to which a communication channel used by the user terminal 300 is closed to a deep fade.

The user terminal 300 may transmit, to the AP 200, feedback information including at least one of SINR information, signal gain information, and the LIF information on each beam. The user terminal 300 may provide specific feedback information, according to each beam, the LIF which is an interference amount to be received by the user terminal 300 based on the feedback information.

The communicator 210 may receive the feedback information based on the beam information from at least one user terminal 300. The communicator 210 may receive all feedback information transmitted from a network of another AP in addition to a network to which the AP 200 belongs. When the feedback information is received from the user terminal 300, the communicator 210 may transmit an acknowledgement (ACK) message indicating that the feedback information is received, to the user terminal 300.

The user terminal selector 240 may select at least one user terminal to which data is to be transmitted from a plurality of the user terminals 300 based on the feedback information received from the at least one user terminal 300. The user terminal selector 240 may select the user terminal to which the data is to be transmitted for each subchannel or each stream based on the feedback information.

The user terminal selector 240 may identify a size of the SINR of each user terminal 300 from the feedback information and select the user terminal 300 to which the data is to be transmitted based on the size of the SINR. For example, the user terminal selector 240 may select the user terminal 300 having a greatest SINR for each subchannel and each stream as a user terminal to which data is to be transmitted. The communicator 210 may broadcast information on the selected user terminal.

The transmission power determiner 250 may determine a transmission power term with respect to each beam based on the feedback information. The transmission power determiner 250 may determine the transmission power condition based on at least one of the LIF information and the SINR information included in the feedback information. Transmission efficiency may be enhanced due to a determination of the transmission power term with respect to each beam. A sum of the SINR in the entire network may be maximized and a throughput of the network may be enhanced due to a control of a transmission power with respect to each beam

In an example, the transmission power determiner 250 may determine the transmission power term with respect to each beam based on the LIF information and the signal gain information received from a user terminal selected by the user terminal selector 240.

As shown in Equation 2, the transmission power determiner 250 may calculate a matrix G value, based on the signal gain information of user terminals selected by the user terminal selector 240.

$$G = [ \begin{matrix}{g}_{11} & & & & & 0 \\ & {g}_{12} & & & & \\ & & {g}_{13} & & & \\ & & & {g}_{22} & & \\ & & & & ⋱ & \\ 0 & & & & & {g}_{K 2}\end{matrix} ] [ \begin{matrix}{g}_{11} & & & & & 0 \\ & {g}_{12} & & & & \\ & & {g}_{12} & & & \\ & & & {g}_{22} & & \\ & & & & ⋱ & \\ 0 & & & & & {g}_{K 2}\end{matrix} ] \qquad [ Equation 2 ]$$

In Equation 2, g_{ab} denotes a signal gain corresponding to a b-th stream of an a-th BSS.

As shown in Equation 3, the transmission power determiner 250 may calculate matrix C value, based on the LIF information of the user terminals selected by the user terminal selector 240. The matrix C includes interference information of each user terminal.

$$C = {I}_{KS \times KS} + [ \begin{matrix}0 & {i}_{11 -> 12} & {i}_{11 -> 21} & {i}_{11 -> 22} & \\ {i}_{12 -> 11} & 0 & {i}_{12 -> 21} & {i}_{12 -> 22} & … \\ {i}_{21 -> 11} & {i}_{21 -> 22} & 0 & & \\ & & & 0 & \\ & & … & & \end{matrix} ] {[ \begin{matrix}0 & {i}_{11 -> 12} & {i}_{11 -> 21} & {i}_{11 -> 22} & \\ {i}_{12 -> 11} & 0 & {i}_{12 -> 21} & {i}_{12 -> 22} & … \\ {i}_{21 -> 11} & {i}_{21 -> 22} & 0 & & \\ & & & 0 & \\ & & … & & \end{matrix} ]}^{H} \qquad [ Equation 3 ]$$

In Equation 3, i_{ab→cd} denotes an element indicating an effect of interference of which a b-th stream transmitted by an a-th AP affects a d-th user terminal belonging to a c-th BSS. Interferences within a BSS and interferences between BSSs may be represented in a form of i_{ab→cd}.

As shown in Equation 4, the transmission power determiner 250 may calculate an eigenvector vₚ which is a power allocation vector, based on the matrix G in Equation 2 and the matrix C in Equation 3.

vₚ=eigenvector corresponding to maximum eigenvalue of G(C)⁻¹ [Equation 4]

The transmission power determiner 250 may calculate the eigenvector vₚ corresponding to a maximum eigenvalue of a value of G(C)⁻¹.

In Equation 4, the eigenvector vₚ including transmission power information on each beam is expressed as shown in Equation 5.

$${v}_{p} = [ \begin{matrix}{p}_{11} \\ {p}_{12} \\ … \\ {p}_{KS}\end{matrix} ] , power allocation vector \qquad [ Equation 5 ]$$

In Equation 5, p_{KS} denotes transmission power adjustment components determined with respect to an S-th stream in a K-th AP network.

After the eigenvector vₚ is obtained, the transmission power determiner 250 may perform scaling with respect to components of the transmission allocation vector and determine the transmission power to be applied to each beam. A condition of scaling may be determined based on a target signal to noise ratio (SNR) of a network. The scaling with respect to the transmission power components may be performed based on Equation 6.

$${p}_{1} = {\sum }_{s = 1}^{S} {p}_{1 s} , … , {p}_{K} = {\sum }_{s = 1}^{S} {p}_{Ks} \\ if {p}_{g} = max ( {p}_{1} , … , {p}_{K} ) \\ {\hat{p}}_{ab} = {p}_{ma x} \frac{{p}_{ab}}{{p}_{g}} for the bth stream of the ath BSS \\ {\hat{p}}_{ab} \text{:} final power allocation for the bth stream of the ath BSS \qquad [ Equation 6 ]$$

In Equation 6, p_{K} denotes a sum of the transmission power adjustment components with respect to S streams to be transmitted from the network of the K-th AP, and p_{g} denotes a maximum value among the sum of the transmission power adjustment components with respect to a network of K APs. \hat{p}_{ab} denotes final power adjustment components with respect to the b-th stream of the network or the BSS of the a-th AP. The communicator 210 may transmit streams to the user terminal 300 based on the final power adjustment components determined with respect to each stream.

In another example, the transmission power determiner 250 may determine a transmission power term based on SINR information received from the user terminal 300. The transmission power determiner 250 may adjust a transmission power to be applied to another user terminal based on a lowest SINR among SINRs of user terminals selected by the user terminal selector 240.

In still another example, the transmission power determiner 250 may adjust a transmission power based on SINR information and LIF information. The transmission power determiner 250 may determine a transmission power term with respect to each beam based on LIF information on each beam transmitted by user terminals and a lowest SINR among SINRs of the at least one user terminal selected by the user terminal selector 240.

The communicator 210 may transmit the data to the at least one user terminal selected by the user terminal selector 240 based on the transmission power term determined by the transmission power determiner 250. The communicator 210 may transmit the data to the user terminal 300 using a beamforming matrix.

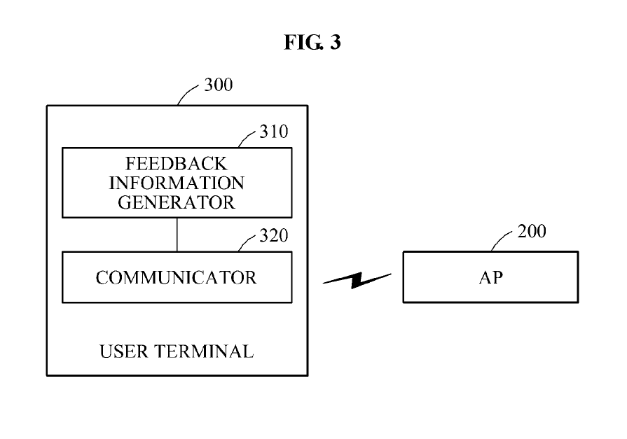

FIG. 3 is a diagram illustrating a configuration of a user terminal according to an embodiment.

Referring to FIG. 3, the user terminal 300 includes a feedback information generator 310 and a communicator 320.

The communicator 320 may receive beam information from the AP 200. The AP 200 may randomly select beams and broadcast the beam information on the selected beams. The beam information may include information on predetermined orthogonal random beams or information on a transmission vector space selected by the AP 200.

The feedback information generator 310 may generate feedback information based on the beam information received from the AP 200. The feedback information generator 310 calculates an LIF and SINR based on the beam information.

The feedback information generator 310 may calculate the SINR expected for each stream based on the information on the transmission vector space. For example, when the feedback information generator 310 receives information on a transmission vector space from the AP 200, the feedback information generator 310 may calculate an expectable SINR with respect to each message symbol stream based on the information on the received transmission vector space. For example, the feedback information generator 310 may calculate an expectable SINR for each symbol stream, as shown in Equation 7.

$${SINR}_{g , a} ( s ) = \frac{{\vert {{w}_{g , a} ( s )}^{H} {H}_{g}^{g , a} {v}_{g , s , initial} \vert}^{2}}{{\vert {{w}_{g , a} ( s )}^{H} ( {{\sum }_{l \neq s}}^{S} {H}_{g}^{g , l} {v}_{g , l , initial} + {\sum }_{k = 1}^{K} {\sum }_{l = 1}^{S} {H}_{k}^{g , l} {v}_{k , l , initai} + {n}_{g , a} ) \vert}^{2}} \qquad [ Equation 7 ]$$

In Equation 7, SINR_{g,a}(s) denotes an SINR expected when an s-th message symbol stream is decoded in a user terminal a belonging to a network of an AP g. w_{g,a}(s) denotes a receive vector available to be used when a message is received through the s-th symbol stream from the user terminal a belonging to the network of the AP g. w_{g,a}(s) is calculated in each user terminal based on zero-forcing or a minimum mean square error (MMSE). n_{g,a} denotes a noise vector in the user terminal a belonging to the network of the AP g, and Hₖ^{g,i} denotes a channel matrix between an AP k and a user terminal 1 belonging to the network of the AP g. H_{g}^{g,i} denotes a channel matrix between the AP g and the user terminal 1 belonging to the network of the AP g, and H_{g}^{g,a} denotes a channel matrix between the AP g and the user terminal a. v_{k,l,initial} denotes an initial vector to be transmitted to each user terminal for an l-th multi-user multi-input multi-output (MU-MIMO) transmission in the network of the AP k, and v_{g,l,initial} denotes an initial vector to be transmitted to each user terminal for the l-th MU-MIMO transmission in the network of the AP k. v_{g,s,initial} denotes an initial vector to be transmitted to each user terminal for an s-th MU-MIMO transmission in the network of the AP g.

The feedback information generator 310 may calculate a signal gain and an LIF with respect to each beam expected during a signal decoding, based on the received beam information. The feedback information generator 310 may calculate the LIF based on interference from another user terminal and interferences between other user terminals exist within a service range of the AP 200. The LIF may include information on interference by another AP and the interferences between other user terminals within the service range.

For example, the feedback information generator 310 may calculate a power affected by the LIF using Equation 8.

$${LIF}_{g , a} ( s ) = {\vert {{w}_{g , a} ( s )}^{H} ( {\sum }_{l \neq s}^{S} {H}_{g}^{g , i} {v}_{g , l , initial} + {\sum }_{k = 1}^{K} {\sum }_{l = 1}^{S} {H}_{k}^{g , l} {v}_{k , l , initial} ) \vert}^{2} \qquad [ Equation 8 ]$$

In Equation 8, LIF_{g,a}(s) denotes a residual power after interference from a network of another AP and IUI between user terminals are decoded when an s-th symbol stream is decoded in the user terminal a belonging to the network of the AP g. w_{g,a}(s) denotes a receive vector available to be used when a message is received through the s-th symbol stream from the user terminal a belonging to the network of the AP g. Hₖ^{g,l} denotes a channel matrix between the AP k and the user terminal 1 belonging to the network of the AP g, and H_{g}^{g,l} denotes a channel matrix between the AP g and the user terminal 1 belonging to the network of the AP g. v_{k,l,initial} denotes an initial vector to be transmitted to each user terminal for an l-th MU-MIMO transmission in the network of the AP k, and v_{g,l,initial} denotes an initial vector to be transmitted to each user terminal for the l-th MU-MIMO transmission in the network of the AP g.

The feedback information generator 310 may generate the feedback information including SINR information, signal gain information, and LIF information, and the communicator 320 may transmit the generated feedback information to the AP 200.

The AP 200 may select user terminals to which data is to be transmitted for each subchannel and each stream based on the received feedback information, and determine the transmission power term based on the SINR information and the LIF information transmitted by the selected user terminals. The AP 200 may transmit the data to the selected user terminals based on the determined transmission power term.

For example, the user terminal 300 may receive the data from the AP 200 and decode the data based on an MMSE receiving filter.

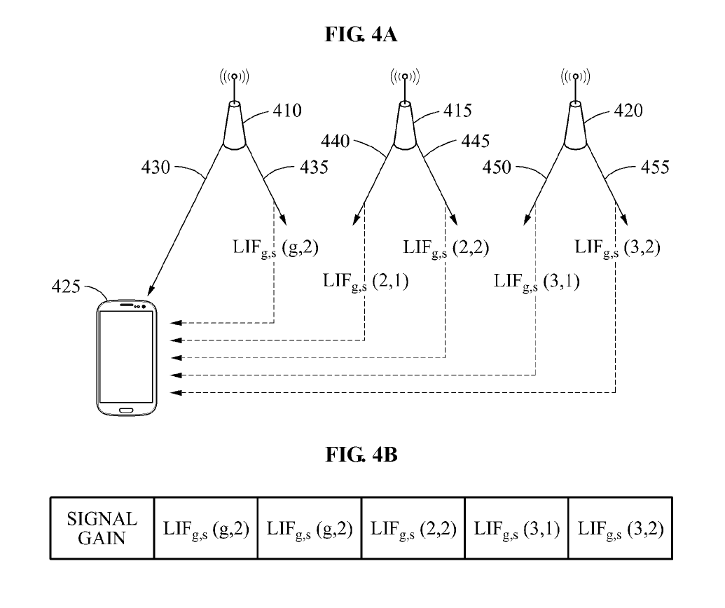

FIGS. 4A and 4B are diagrams illustrating feedback information generated by a user terminal according to an embodiment.

Referring to FIG. 4A, a user terminal 425 calculates a signal gain and an LIF with respect to each of beams 430, 435, 440, 445, 450, and 455 to be transmitted from a plurality of APs 410, 415, and 420, and broadcasts feedback information including calculated signal gain information and LIF information on each of the beams 430, 435, 440, 445, 450, and 455. FIG. 4B illustrates an example of a configuration of the feedback information generated by the user terminal 425. Referring to FIG. 4B, the feedback information includes the signal gain information and the LIF information on each of the beams 430, 435, 440, 445, 450, and 455.

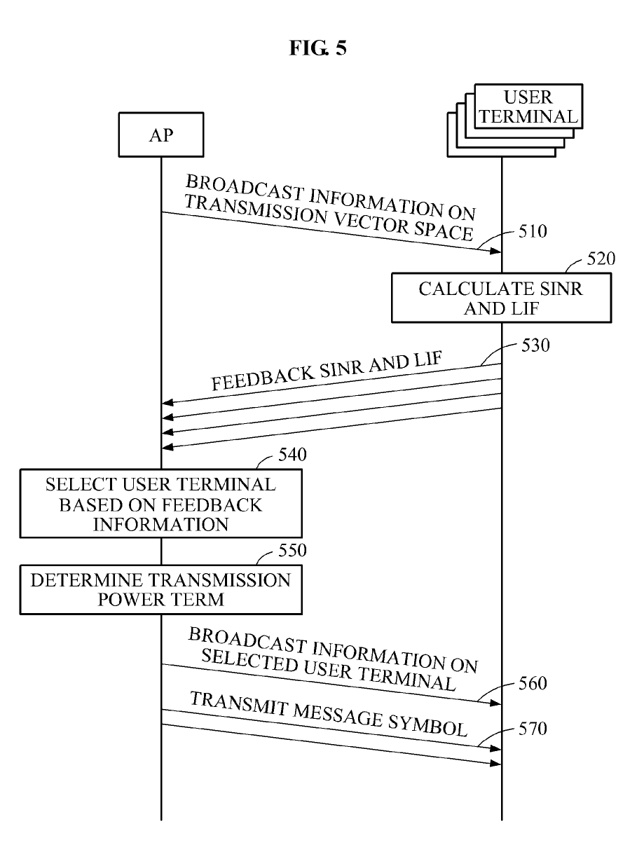

FIG. 5 is a diagram illustrating a protocol of opportunistic interference alignment (OIA) occurring between an AP and a user terminal according to an embodiment.

In operation 510, an AP randomly selects a transmission vector space and broadcasts information on the selected transmission vector space to user terminals. The AP may designate a signal vector used for a data transmission by selecting the transmission vector space.

In operation 520, the user terminals receive the information on the transmission vector space from the AP, and calculate an SINR and an LIF with respect to each beam based on the received information on the transmission vector space.

In operation 530, the user terminals feedback the SINR and the LIF calculated in operation in 520 to the AP.

In operation 540, the AP selects a user terminal to which data is transmitted for each subchannel or each symbol stream based on the received feedback information. For example, an AP may select a user terminal to which data is to be transmitted based on a size of SINR of the user terminal.

In operation 550, the AP determines a transmission power term with respect to each stream based on SINR information and LIF information received from the user terminals.

In operation 560, the AP broadcasts information on the user terminal selected in operation 540.

In operation 570, the AP transmits, based on an MU-MIMO scheme, a message symbol to the user terminal selected in operation 540 based on the transmission power term determined in operation 550. Based on the aforementioned operations, a throughput may be enhanced, and interference occurring in another network may decrease when compared to a transmission power.

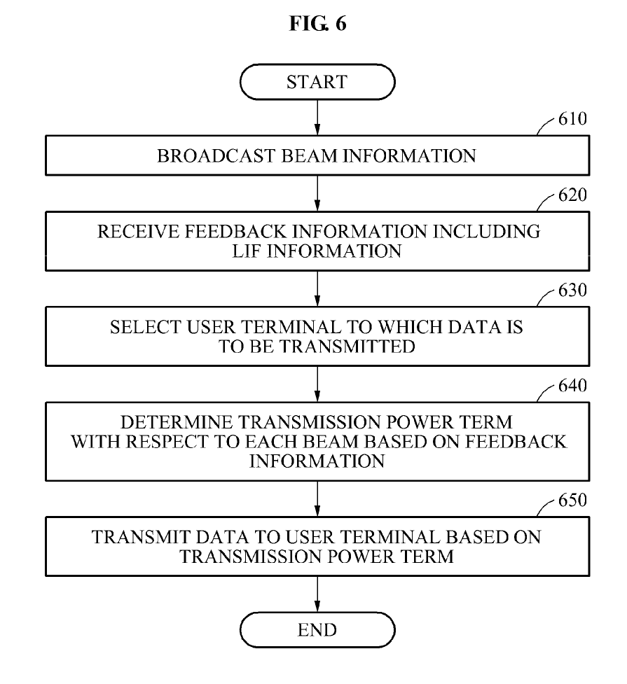

FIG. 6 is a flowchart illustrating a method for IA performed by an AP according to an embodiment.

In operation 610, the AP broadcasts beam information. The AP may randomly select a transmission vector space and generate the beam information on the selected transmission vector space.

In operation 620, the AP receives, from user terminals, feedback information including LIF information on each beam. The feedback information may include signal gain information, the LIF information on each beam, and SINR information.

In operation 630, the AP selects at least one user terminal to which data is to be transmitted based on the feedback information. The AP selects the at least one user terminal to which the data is to be transmitted for each subchannel or each stream. The AP may identify a size of the SINR of each user terminal from the feedback information and select the at least one user terminal to which the data is to be transmitted based on the size of the SINR.

In operation 640, the AP determines a transmission power term with respect to each beam based on the feedback information. The AP may determine the transmission power term based on at least one of the LIF information and the SINR information included in the feedback information. For example, an AP may calculate a matrix value, for example, Equation 2, based on signal gain information of user terminals to which data is to be transmitted, and calculate a matrix value, for example, Equation 3, based on LIF information of the user terminals to which the data is to be transmitted. The AP may calculate a eigenvector based on the matrix values calculated in Equations 2 and 3, and determine a transmission power to be applied to each beam by scaling elements configuring the eigenvector.

In operation 650, the AP transmits the data to the at least one user terminal selected in operation 630, based on the transmission power term.

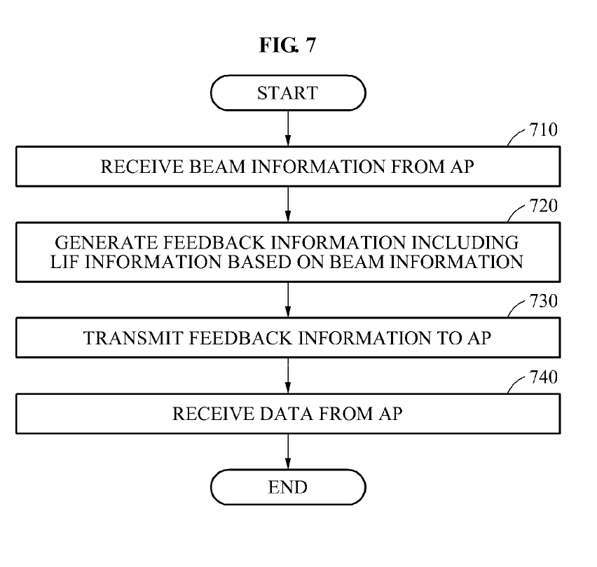

FIG. 7 is a flowchart illustrating a method for IA performed by a user terminal according to an embodiment.

In operation 710, the user terminal receives beam information from an AP. The beam information may include information on a transmission vector space randomly selected by the AP.

In operation 720, the user terminal generates feedback information including LIF information based on the beam information. The user terminal may calculate an SINR expected for each stream based on the information on the transmission vector space included in the beam information and calculate an LIF with respect to each beam expected when a signal is decoded. The feedback information may include LIF information, SINR information, and signal gain information.

In operation 730, the user terminal transmits the feedback information to the AP.

In operation 740, the user terminal receives data from the AP. The AP may determine a transmission power term with respect to each subchannel or each stream based on the feedback information received from the user terminal, and transmit the data to the user terminal based on the determined transmission power term.

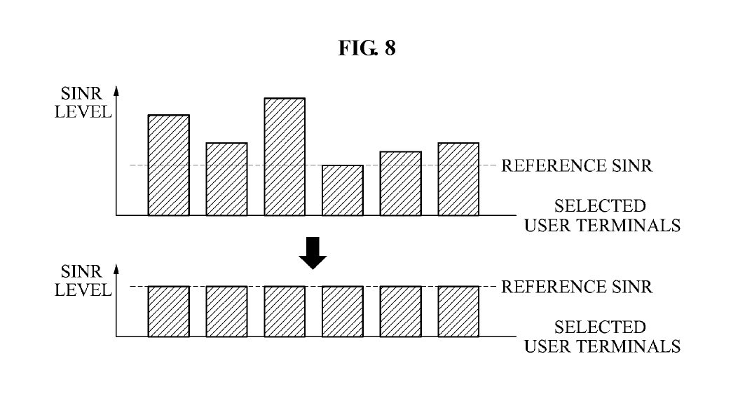

FIG. 8 is a diagram illustrating a method of controlling a transmission power based on a signal to interference plus noise ratio (SINR) according to an embodiment.

An AP may determine the transmission power to be applied to each stream based on SINRs of user terminals. When the AP selects a user terminal to which data is to be transmitted for each stream, the selected user terminal may have different levels of the SINR. In this instance, when the transmission power is adjusted based on the provided levels of the SINR, a throughput of a network may enhance.

The AP may set a lowest SINR among the SINRs as a reference SINR and adjust the transmission power based on the reference SINR. For example, an AP may adjust a transmission power using Equation 9.

$${P}_{SINR} ( g , s ) = \frac{min {SINR}_{ma x} ( : \text{,} : )}{{SINR}_{ma x} ( g , s )} \qquad [ Equation 9 ]$$

In Equation 9, P_{SINR}(g, s) denotes a transmission power component determined for an s-th stream in a network of an AP g. min SINRₘₐₓ(:,:) denotes a lowest level among maximum levels of the SINRs transmitted by the selected user terminals, and SINRₘₐₓ(g, s) denotes a maximum level of an SINR of a user terminal selected with respect to the s-th stream in the network of the AP g. An interference effect may be reduced due to a power adjustment process with respect to each stream thereby increasing throughputs of entire network.

The various modules, elements, and methods described above may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Functional programs, codes, and code segments for implementing the examples disclosed herein can be easily constructed by a programmer skilled in the art to which the examples pertain based on the drawings and their corresponding descriptions as provided herein.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An interference alignment (IA) method performed by an access point (AP), the method comprising:
broadcasting beam information on randomly selected beams;
receiving, from user terminals, feedback information comprising leakage of interference (LIF) information on each beam;
determining a transmission power term with respect to each beam based on the feedback information; and
transmitting data based on the determined transmission power term.

2. The method of claim 1, further comprising:
selecting at least one user terminal to which the data is to be transmitted from the user terminals.

3. The method of claim 2, wherein the determining comprises determining the transmission power term based on signal gain information and the LIF information received from the at least one selected user terminal.

4. The method of claim 3, wherein the determining comprises:
calculating a power allocation vector based on a first matrix corresponding to the LIF information received from the at least one selected user terminal and a second matrix corresponding to the signal gain information received from the selected at least one user terminal;
scaling the power allocation vector; and
determining the transmission power term based on the scaled power allocation vector.

5. The method of claim 1, wherein the feedback information further comprises signal to interference plus noise ratio (SINR) information.

6. The method of claim 5, wherein the determining comprises determining the transmission power term with respect to each of the beams based on the LIF information and the SINR information.

7. The method of claim 1, wherein the broadcasting comprises:
randomly selecting a transmission vector space; and
broadcasting beam information based on information on the selected transmission vector space.

8. The method of claim 2, wherein the selecting comprises selecting the at least one user terminal to which the data is to be transmitted from the user terminals based on a level of an SINR measured by the user terminals.

9. The method of claim 2, wherein the selecting comprises selecting at least one user terminal to which the data is to be transmitted for each subchannel or each stream based on the feedback information.

10. The method of claim 2, further comprising:
broadcasting information on the at least one selected user terminal.

11. The method of claim 1, wherein the LIF information comprises at least one of information on an interference occurring at another user terminal within a service area of the AP and information on an interference occurring at another AP.

12. An interference alignment (IA) method performed by a user terminal, the method comprising:
receiving beam information on randomly selected beams from an access point (AP);
generating feedback information comprising leakage of interference (LIF) information on each beam based on the beam information;
transmitting the generated feedback information to the AP; and
receiving data from the AP according to a transmission power term determined based on the feedback information.

13. The method of claim 12, wherein the transmission power term is determined based on the LIF information on each beam and signal gain information calculated by the user terminal.

14. The method of claim 12, wherein the AP selects at least one user terminal to which the data is to be transmitted from user terminals, and the transmission power term is determined based on a first matrix corresponding to the LIF information received from the at least one selected user terminal and a second matrix based on signal gain information received from the at least one selected user terminal.

15. The method of claim 12, wherein the generating comprises generating the feedback information further comprising signal gain information and a signal to interference plus noise ratio (SINR) information.

16. An access point (AP), comprising:
a communicator configured to broadcast beam information on randomly selected beams and receive feedback information from user terminals; and
a transmission power determiner configured to determine a transmission power term with respect to each beam based on leakage of interference (LIF) information on each beam comprised in the feedback information.

17. The AP of claim 16, further comprising:
a user terminal selector configured to select at least one user terminal to which data is to be transmitted for each subchannel or each stream based on the feedback information.

18. The AP of claim 17, wherein the transmission power determiner is configured to determine the transmission power term based on signal gain information and the LIF information received from the at least one selected user terminal.

19. The AP of claim 17, wherein the transmission power determiner is configured to calculate a power allocation vector based on a first matrix based on the LIF information received from the at least one selected user terminal and a second matrix based on the signal gain information received from the at least one selected user terminal, and determine the transmission power term based on the power allocation vector.

20. The AP of claim 17, wherein the communicator is configured to broadcast information on the at least one selected user terminal and transmit data to the at least one selected user terminal based on the determined transmission power term.
